(19) United States
(12) Patent Application Publication
(10) Pub. No.: US 2019/0168232 A1
(43) Pub. Date: Jun. 6, 2019

(54) Multi-Purpose Plant Flower Trimmer and Separator

(71) Applicant: Thomas Joseph Bruggemann, Woodland Hills, CA (US)

(72) Inventor: Thomas Joseph Bruggemann, Woodland Hills, CA (US)

(21) Appl. No.: 15/786,441

(22) Filed: Oct. 17, 2017

Related U.S. Application Data
(63) Continuation-in-part of application No. 15/469,525, filed on Mar. 25, 2017.
(60) Provisional application No. 62/424,778, filed on Nov. 21, 2016.

(51) Int. Cl. B02C 17/18; B02C 17/02; A01F 12/44

(52) U.S. Cl. CPC B02C 17/1855; A01F 12/442; B02C 17/02

(57) ABSTRACT

Floor-standing equipment and methods that employ them use nylon netting and/or fine mesh to trim off leafy matter, break down leafy matter, and separate various aspects of plants from each other. The netting and/or fine mesh is formed into large cylindrical drum into which plant material is loaded through a door flap in the mesh cylinder. An electric motor or handcrank causes the load to tumble over and over a horizontal axle for 3-5 minutes at about 35 RPM. The plant matter trims, separates, and breaks itself down which then drops through the netting, down through a funnel bag into a basin on the floor. The flowers and/or larger plant material are then dropped out separately through the door flap in the netting and through the funnel bag into a second basin on the floor which replaced the first.

### FIELD OF INVENTION

The present invention relates to multi-purpose equipment and methods for dry trimming plant flowers of leafy matter, for separating fine materials from trim, for separating seeds from plant matter, and for breaking down large leaf and plant matter into smaller particles. And more specifically to those that employ ½″ and ¼″ netting formed into cylindrical tumbler drums turned on a horizontal axle to gently separate and delicately trim the flower of leaf matter with minimal damage and/or loss of trichomes and crystals. And using fine screens in place of the netting to isolate pollen, trichomes, and crystals from leafy trim.

### BACKGROUND OF THE INVENTION

Plants of particular varieties may have flowers with leafy matter that can be mechanically trimmed so as to remove or separate the leafy matter from the flower. And the plants may have trichomes (or hairlike outgrowths) that my harbor components that may be further separated and collected. Cannabis plants comprise several different components and structures. Plants can be male, female, or hermaphrodite. Flowers of some plants are most prized because they have the highest concentrations of certain components. These flowers or buds are rather easy to separate from the larger leaves and stems, but the buds themselves are infiltrated with protruding leaf matter that needs careful “trimming” so as not to break off or lose crystals and trichomes embedded in the buds.

Such trimming can be easily and carefully done by hand for low volumes. But commercial production requires automated methods. Conventional equipment has employed metal blades and rotating scissors disks that loosely resemble electric hair trimmers. Such traditional equipment can be very harsh on the buds themselves and make a mess of the final product. These blades also need lubricating and these lubricants can contaminate the final products.

Conventional trimmers use metal blades that need regular lubrication with oil, and therefore regular cleaning and maintenance. The blade lubrication oil eventually winds up in the product and can become toxic when smoked or ingested.

Kief, which is the resinous trichomes of cannabis, referred to here as trichome crystals, are fine outgrowths on the plants that protect and promote the genetic material in a plant's seeds in many different ways. Cannabis and other plants that depend on the wind to carry their pollens do not emit terpenes, flavonoids, and other odors that encourage pollination by attracting bees and other insects. Some trichomes have developed psychoactive chemicals that will intoxicate herbivores or make them ill. These pharmacological effects will distract herbivores enough not to eat the plant. Other trichomes build physical barriers, like cotton fibers, that make it difficult for beetles and other pests to get to the seeds.

Different mesh sizes of silkscreen are used for different applications in screen printing. Mesh size is measured by how many threads of mesh there are crossing per square inch. For instance, a 110-mesh screen has 110 cross-threads per inch. The higher the mesh count, the finer the holes will be in the screen, generally speaking.

Printing silkscreen has been found to be a very useful pollen and trichome crystal filtering material.

### SUMMARY OF THE INVENTION

Briefly, both floor-standing equipment and method embodiments of the present invention trim leafy matter off the buds or flowers of plants by tumbling them around in a continuous curling wave that knocks the flowers or buds together and that grates them along a nylon netting, and allowing the leafy trim to pass through the holes in the netting, thus isolating the trimmed buds or flowers which remain in the tumbler drum. The netting is formed into large cylindrical drum into which dried flowers of plants are loaded through a door flap in the netting. An electric motor or handcrank causes the load to tumble over and over a horizontal axle for several minutes at about 25 to 45 RPM. The trim drops through the netting down through a funnel bag into a basin on the floor. The trimmed seedless flowers are then dropped out separately through the door flap in the netting and through the funnel bag into a second basin on the floor.

In other embodiments, the floor-standing equipment is operated as a trimmer, a popcorn-size bud separator, and a trichome crystal-separator, and pollen separator by simply changing the netting to use different sized openings and even silkscreens with different mesh sizes.

These and other objects and advantages of the present invention no doubt become obvious to those of ordinary skill in the art after having read the following detailed description of the preferred embodiments which are illustrated in the various drawing figures.

### BRIEF DESCRIPTION OF THE DRAWINGS

FIG. 1A is a perspective view diagram of the floor standing frame, motor drive, and horizontal axle cylindrical tumbling drum form for a flower trimmer embodiment of the present invention;

FIG. 1B is a perspective view diagram of how a rectangular patch of netting is wrapped around the horizontal axle cylindrical tumbling drum form of the flower trimmer of FIG. 1A;

FIG. 1C is a side view of the flower trimmer of FIG. 1A without the floor-standing frame so the funnel bag chute and a removal catch basin can be shown in relation to the cylindrical tumbling drum that is covered with the netting;

FIG. 2 is a side view of the cylindrical tumbling drum of FIGS. 1A-1C that is covered with the netting and is shown here to include a zippered door flap and radial lips on the opposing drum ends;

FIGS. 3A-3F illustrate the steps in a method embodiment of the present invention for using the equipment described to trim extraneous matter from the flowers of plants;

FIGS. 4A-4C illustrate the steps in a method embodiment of the present invention for using the equipment described to extract trichome crystals from extraneous matter earlier separated during trimming from the flowers of plants;

FIG. 5 is a perspective diagram of an inexpensive and portable version of the trimmers described in the above FIGS.;

FIG. 6 is an exploded assembly and partial cross sectional view of a motor and tumbler drum drivetrain useful in embodiments of the present invention. These pieces all couple together with matching female pipe threads (FPT) and male pipe threads (MPT);

FIG. 7 is a perspective view of a clear vinyl dustcover that can be slipped over the PVC framework of a trimmer like that of FIG. 5; and

FIGS. 8A and 8B are perspective views of a baby-carriage type folding top dustcover in its open (FIG. 8A) and closed (FIG. 8B) positions.

### DETAILED DESCRIPTION OF THE EMBODIMENTS

While the specification herein occasionally describes embodiments in the context of hops plants and cannabis plants, other plants having separable components may be used, and the embodiments described and claimed are not specific to or limited to any application with a particular variety of plant.

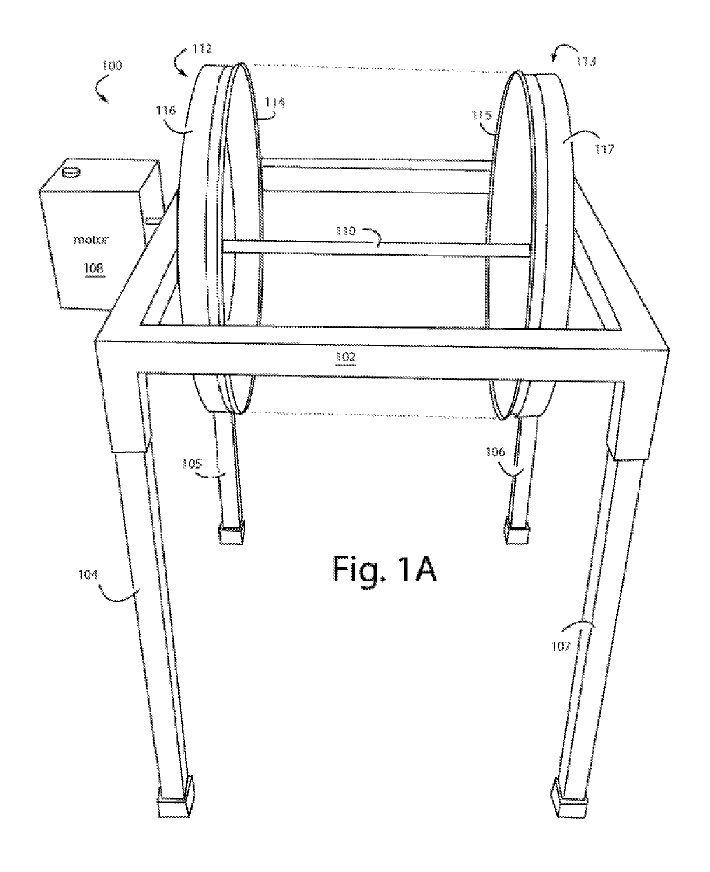

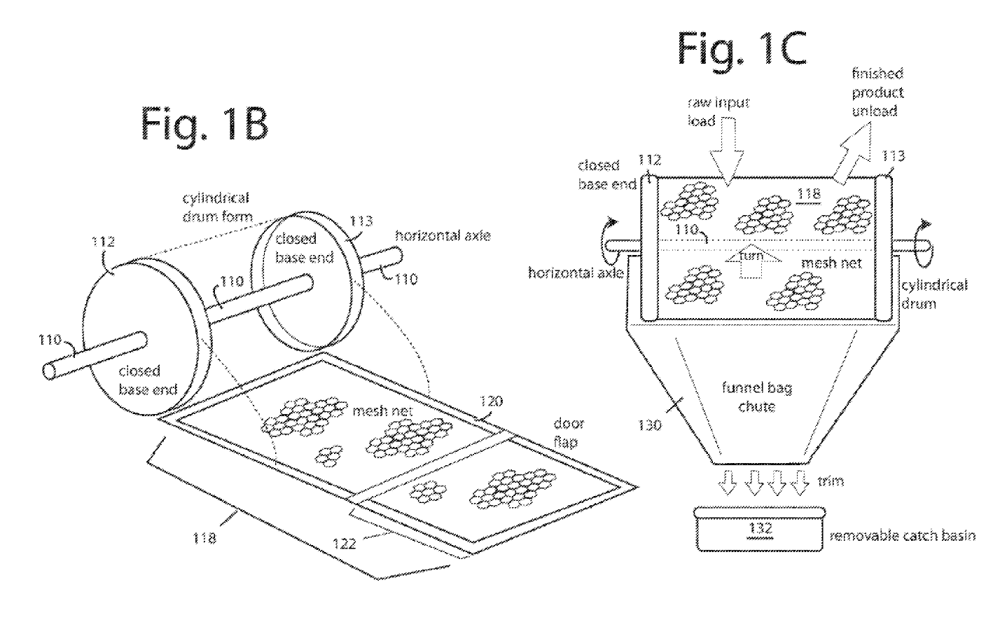

FIGS. 1A-1C represent a floor-standing flower trimmer embodiment of the present invention and is referred to herein by the general reference numeral 100. The floor-standing trimmer 100 is user-assembled onsite from a shipping box of pieces that include a rectangular frame of welded box metal channel 102, four matching removable legs 104-107, a variable speed electric motor 108, a horizontal axle 110 set inside the width of the frame 102 and driven by the motor 108, and two inwardly dished cylindrical end plates 112-113 coaxially mounted on the horizontal axle 110. The two inwardly dished cylindrical end plates 112-113 have lips 114 and 115 radially turned outward. Two lengths of hook-and-loop tape 116 and 117, such as VELCRO brand, are wound around and glued to fully wrap around 360-degrees of each of the two cylindrical end plates 112-113.

FIG. 1B shows how a tumbler drum is formed with netting. A rectangular patch of nylon netting 118 is fringed along its outside edges with one part of a hook-and-loop tape 120 about 1.5″ wide. The rectangular patch of nylon netting is wide enough to bridge over and overlap both outside diameters of the two inwardly dished cylindrical end plates 112-113, and is long enough to fully wrap around 360-degrees to form a large cylindrical drum. A door flap 122 fitted with zippers and/or hook-and-loop tape allows user access to load in and unload materials during use. Protective inside flaps should be included to cover the zippers such that they do not get clogged with trichome crystals or other fine materials.

The two matching and opposing dished cylindrical end plates 112-113 have radially turned outward lips 114 and 115 that help seal with the netting 118 and to exclude debris from fouling the opposing hook-and-loop tape pieces. Typical diameters for the two cylindrical end plates 112-113 range from 17″ to 22″, depending on the target weights of materials to be batch processed.

The variable speed electric motor 108 preferably has a variable range of zero to 45 RPM. Near zero, its speed control is used to position the tumbler drum for loading and unloading of material. In operation, the material loaded inside will begin to roll around in a log until the speed gets high enough for it to break in waves and tumble over the horizontal axle 110. The best speed, about 35 RPM produces a continuous curling wave of material inside the tumbler drum. This is best run for 3 to 5 minutes. At too high a speed, centrifugal force will press the material all along the inside for full rotations. Too high a speed prevents the trimming action from operating properly or efficiently. But speeds as low as 20 RPM are useful when the user intends for the trimming to be as gentle as possible.

FIG. 1C shows a clear vinyl, rectangular funnel bag chute 130 that is hung inside frame 102 and legs 104-107, but outside the bottom half of the large cylindrical drum formed by the netting and the two cylindrical end plates 112-113. The purpose of this rectangular funnel bag is to direct materials dropping through the netting, or through a door flap in the netting, down into a smaller opening dishpan basin 132, like a 16″×12″×8″ RUBBERMAID DISHPAN. Making the funnel bag chute 130 of clear vinyl helps the user to see the progress of the trimming and to see the trim materials dropping through inside.

The structural pieces of trimmer 100 are generally comprised of steel and/or aluminum. Overall, the trimmer 100 is floor-standing and generally about 60″ tall, 36″ wide, and about 36″ deep. Lighter duty embodiments are generally smaller and weigh less, and are limited to processing smaller-weight loads.

The trimming action is not unlike the polishing action that occurs inside a rock polisher that tumbles loose rocks around inside a drum. The flowers knock against each other while tumbling around, and that break downs and breaks off any remaining protruding leafy matter. The finished value of trimmed buds is maximum when the trichomes and crystals remain on the buds.

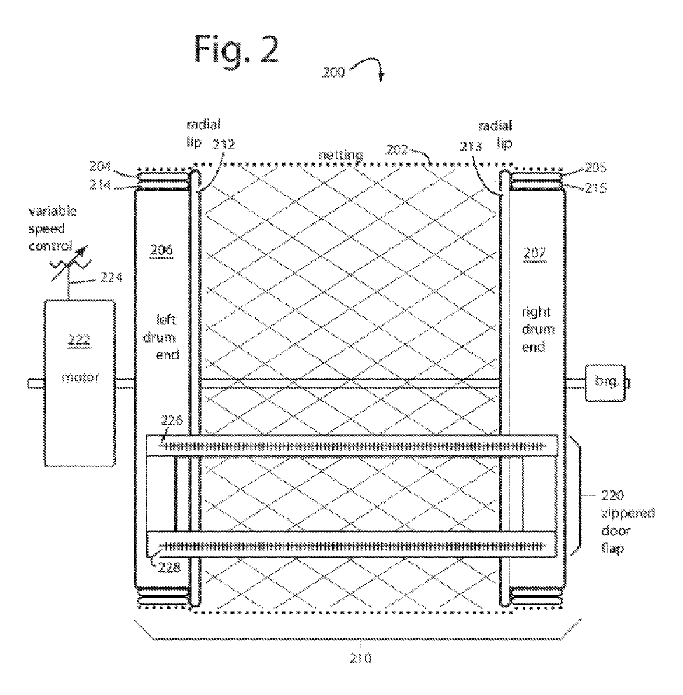

FIG. 2 represents a drum and motor assembly 200, in an embodiment of the present invention. A rectangular patch of nylon netting 202 has a hook-and-loop tape trimming 204, 205 about 1.5″ wide all around its outside longitudinal and lateral perimeters. The rectangular patch of nylon netting 202 is wide enough to bridge over and still overlap both outside diameters of two inwardly dished cylindrical end plates 206, 207. And the rectangular patch of netting 202 is long enough in its length to fully wrap around and seal 360-degrees of the respective diameters to form a large cylindrical drum 210.

The two inwardly dished cylindrical end plates 206, 207 have radially turned out lips 212, 213 to help seal with the netting 202 and to exclude fugitive debris from fouling the opposing hook-and-loop tape pieces 204-205 and 214-215. These matching lengths of hook-and-loop tape 214-215 are wound around and glued to fully wrap all 360-degrees of the circumferences of each of the two cylindrical end plates 206-207. Typical diameters for the two cylindrical end plates 206-207 range from 16″ to 26″, so the length of the netting 202 and the matching lengths of hook-and-loop tapes 204, 205, 214, and 215 will easily run about 70″.

A zippered door flap 220 is included in the rectangular patch of nylon netting 202 and allows easy user access to the interior of the large cylindrical drum 210. A variable-speed electric motor 222 is provided with a variable speed control rheostat 224 which permits a user to easily rotate and position the zippered door flap 220 to the top or the bottom of the large cylindrical drum 210. Such zippered door flap 220 would be best positioned to the top when loading in materials. Similarly, such zippered door flap 220 would be best positioned to the bottom when the materials need to be dumped through the clear vinyl, rectangular funnel bag that is hung inside frame 102 and legs 104-107, down to a dishpan basin. Two parallel zippers 226 and 228 are preferred since this can save wear-and-tear on the hook-and-loop tapes.

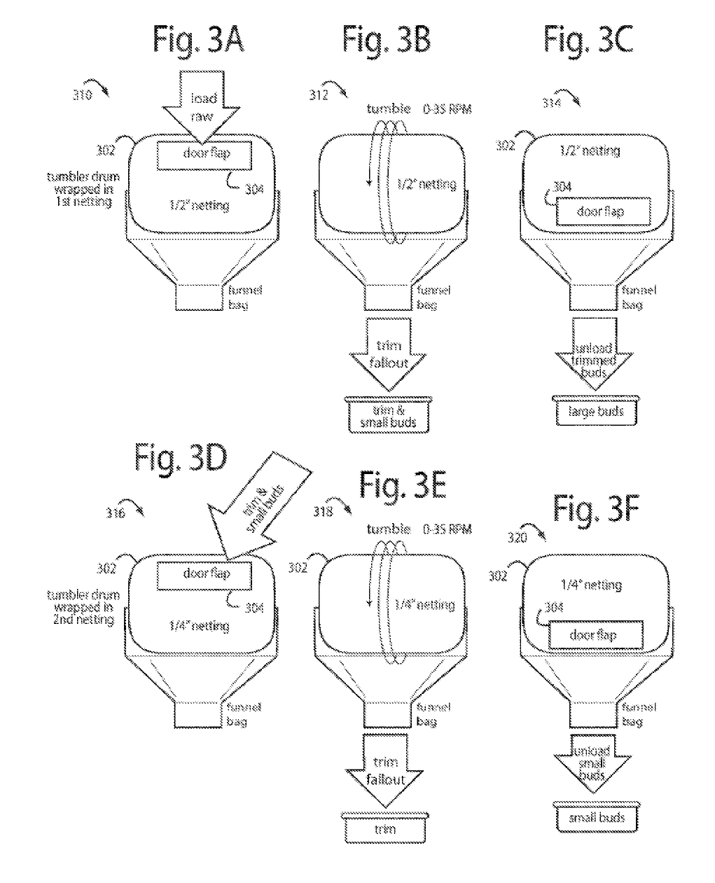

FIGS. 3A-3F represent the steps in a method for trimming, for example, the seedless flower buds of female cannabis plants. The large cylindrical drum 210 of FIG. 2 is represented here as a tumbler drum 302 with a zippered door flap 304. In FIGS. 3A-3C the tumbler drum 302 is fitted with ½″ netting, and in FIGS. 3D-3F, the tumbler drum 302 is retro-fitted with ¼″ netting. The initial use of ½″ netting in FIGS. 3A-3C allows small flower “popcorn-size” buds to fall through that must be separated from the trim and recaptured in FIGS. 3D-3F.

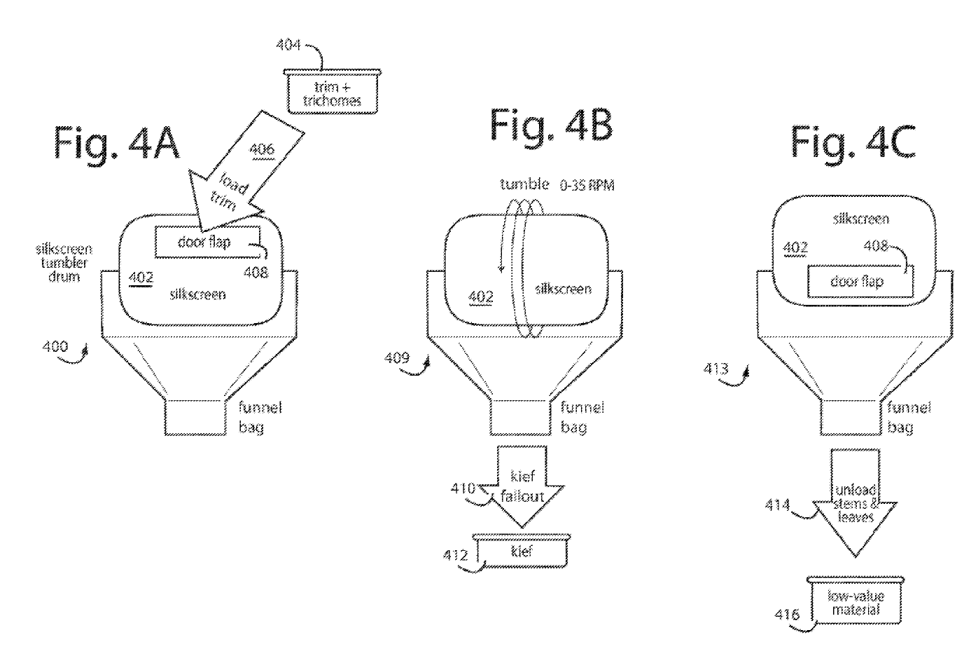

In FIG. 3A, a first step 310 begins with loading a dry quantity of, for example, cannabis, e.g., 3-6 pounds, into the tumbler drum 302 through the door flap 304 while it is positioned near the top. In FIG. 3B, a next step 312 uses the motor or a handcrank to turn the tumbler drum 302 near maximum speed until trim debris visually ceases to flow out, e.g., 20-45 RPM for five minutes. The trim fallout, which includes small leaves, trichome crystals, and small flower “popcorn-size” buds are collected in a dishpan basin with the assistance of a clear vinyl, rectangular funnel bag (not shown here). See FIGS. 4A-4C for the deliberate isolation of the trichome crystals from trim into a final product.

In FIG. 3C, a step 314, a fresh, empty dishpan basin is placed below, the door flap 304 is opened, and rotated to the bottom position such that the large flower buds all drop into the empty dishpan basin. This product then is held in reserve as a better, more valuable part of the final quantity of trimmed buds. The “netting is then exchanged for ¼” netting on tumbler drum 302.

In FIG. 3D, a step 316, the contents of dishpan basin from step 312 is loaded through the door flap 304 after it's rotated to the top position. In FIG. 3E, a next step 318 uses the motor or handcrank to again turn the tumbler drum 302 near maximum speed until trim debris visually ceases to flow out, e.g., 20-45 RPM for five minutes. The small flower “popcorn-size” buds stay inside tumbler drum 302 and only trim pieces are collected below in another dishpan basin. Again, the use of a clear vinyl, rectangular funnel bag helps the user to see when the step is concluded.

In FIG. 3F, a step 320, a fresh, empty dishpan basin is placed below, the door flap 304 is opened, and rotated to the bottom position such that the small, now trimmed, “popcorn-size” flower buds all drop into the empty dishpan basin. This product then added to the large trimmed buds that were held in reserve from step 314 in FIG. 3C.

The standard measure of screen “mesh size” relates to how many threads per inch are present. But the gaps between these threads will narrow as the threads get thicker. The preferred embodiments here use 110 micron or 151-195 micron screens to allow some control over the size of particles being isolated.

The floor-standing trimmer 100 of FIG. 1 can change function between being a traditional trimmer, popcorn-size bud separator, and trichome crystal-separator (aka pollinator) by the user's changing of the netting between ½″, ¼″, and 110-120 silkscreen. A trichome crystal-separator (aka pollinator) separates the fine powdery trichome and bits of crystalized resin from the trim obtained in FIG. 3E, step 318.

The stalks of mature trichomes typically reach a maximum diameter of about 40-microns. And the corresponding heads are usually three times that, about 120-micron, with a maximum of 135-microns. So, mesh sizes above 120 (125-micron pass through) are not commonly used in separating trichome crystals. Any mesh that is too fine will block the largest trichome heads from passing through the silkscreen mesh.

A 170-mesh (88-micron pass through) blocks most the mature trichome heads. Any trichome stalks that do break off will be small enough to pass through even finer mesh sizes. If the intention is to deliberately separate the heads from the stalks, then a 200-mesh screen (74-micron) is called for. Going the other way, classic Afghani pressed hash, for example, has a large amount of debris because large, 50-60 mesh screens are used.

FIGS. 4A-4C represent a change of a trimmer 100 into a fine material- or trichome crystal-separator (aka pollinator). Essentially, the nylon netting is replaced by a 110-micron silkscreen covered drum 402 that will pass through the trichomes by retaining anything larger size inside. In a first step 400, illustrated in FIG. 4A, a dishpan basin 404 of plant trim and random bits of trichomes are poured 406 through a door flap 408 in drum 402 positioned near the top. A second step 409 is illustrated in FIG. 4B. The silkscreen covered drum 402 is rotated by motor or hand crank to tumble the material from dishpan basin 404 around inside for several minutes at 0-45 RPM. A trichome crystal fallout 410 will form on the outside surface of the silkscreen mesh and most will fall to the floor where another dishpan basin 412 is set by the user to catch it. A third and final step 413 in FIG. 4C includes stopping the drum 402 with the door flap 408 at the bottom and open. This will allow gravity to help unload steams, leaves, and other trim 414 into a third dishpan basin 416. Some scraping or pushing by hand or with a tool may be needed to clear it all.

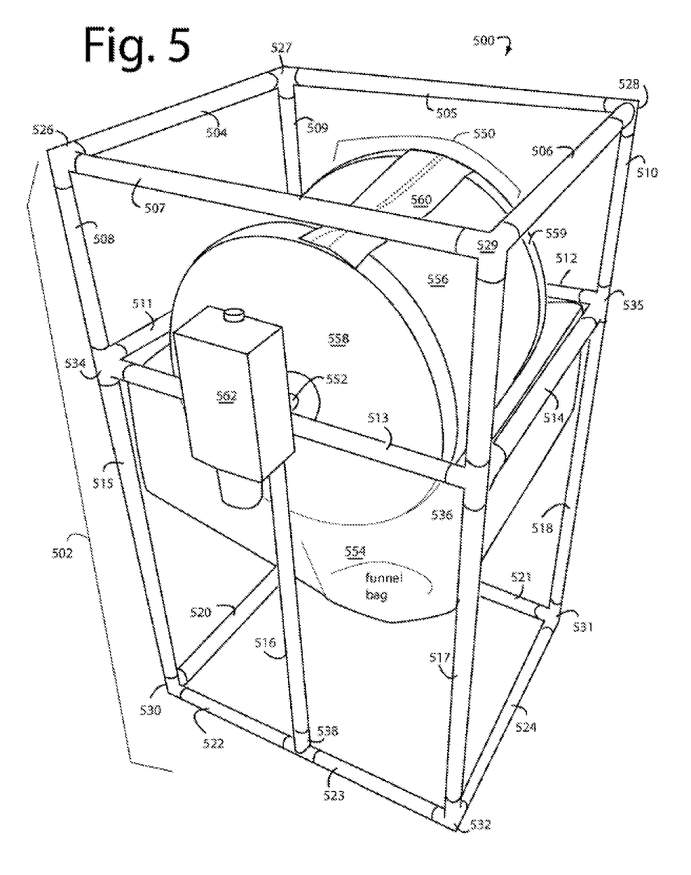

FIG. 5 represents a low cost trimmer 500 in an embodiment of the present invention that is less expensive, easier to transport, and lighter-duty than trimmer 100 of FIG. 1. Its frame 502 is entirely made up of ½″ or ¾″ PVC pipe sections 504-524, socket elbow-tees 526-532, socket cross-elbows 534-536, and socket-tees 538. (Some elements not able to be shown in this perspective view are not numbered.) These pieces are delivered mostly unassembled to typical retail end users and are dry fitted together without glue for use by them. Not using glue allows the trimmer 500 to be disassembled again and more readily transported.

A cylindrical drum form 550 about 19″ in diameter and 20″ in length is supported for turning with a horizontal axle 552. Such is positioned inside the top half of frame 502 and a clear vinyl funnel bag 554 is positioned inside the bottom half of frame 502 to catch loosened trim that escapes through a covering of netting 556. At its top, the clear vinyl funnel bag 554 circuits completely around the bottom half outer diameters of cylinder ends 558 and 559, and does so without contacting or dragging on the netting 556 or cylinder ends 558 and 559. A smaller opening at the bottom of the clear vinyl funnel bag 554 neatly focuses the loose trim into a dishpan basin set below on the floor by the user.

A zippered door flap 560 is stitched into the netting 556 and allows materials to be loaded and unloaded from inside the cylindrical-drum netting enclosure formed by elements 550,556,558,559. A variable-speed electric motor 562 is connected to turn the netting enclosure on horizontal axle 552 at 0-45 RPM. A wide, soft-bristle brush mounted to the back of the frame and positioned to gently sweep along the whole width of surface of the netting enclosure as it turns on horizontal axle 552 can help automatically clear the netting of snags of stems and leaves. A clear vinyl dust cover (not shown) may sometimes be used and is slipped over the outside of the top half of frame 502 to prevent too much fugitive powder and debris from flying out into the air and onto the surrounding floor.

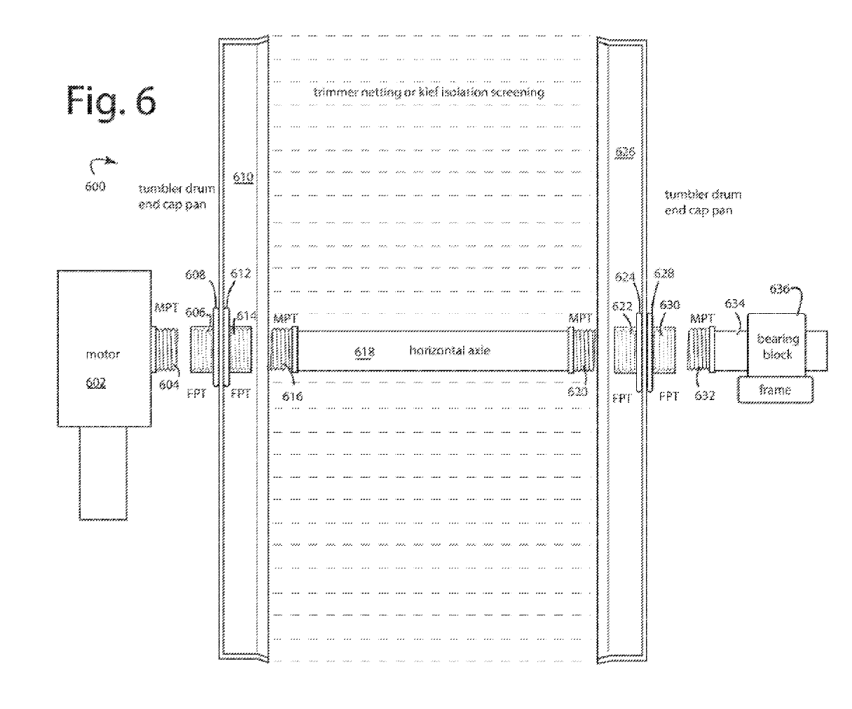

FIG. 6 represents a motor and tumbler drum drivetrain 600 useful in various embodiments of the present invention. A critical aspect of what is shown here is that the major pieces all couple together with matching female pipe threads (FPT) and male pipe threads (MPT). For example, ½″ and ¾″ in both PVC and steel pipes and fittings are widely available and relatively inexpensive. A variable speed electric motor 602 can be adjusted by a user to turn a whole tumbler drum assembly at 0-45 RPM. The motor 602 is mounted at a left end to a supporting floor-standing frame. A MPT 604 threads into a FPT 606 mounted by a first flange 608 to a left tumbler drum end cap pan 610. The left tumbler drum end cap pan 610 is dished and open here to the right.

A second flange 612 and FPT 614 provide a supporting coupling through to a horizontal axle 618 that carries over to the right side in this FIG. 6. A MPT 620 threads into a FPT 622 and a third flange 624, these couple through right tumbler drum end cap pan 626 to a fourth flange 628 and FPT 630. A MPT 632 on one end of a coupler pipe 634 provides rotational distal support with a bearing block 636 mounted to the supporting floor-standing frame. One advantage of building motor and tumbler drum drivetrain 600 with common MPT and FPT water pipe pieces is they make for easy field assembly and disassembly onsite by the user.

Dashed lines are used in FIG. 6 between the left and right tumbler drum end cap pans 610 and 626. These represent the nylon netting used during trimming and the alternative mesh screening used for trichome crystal isolation.

In general, preferred embodiments of the present invention include a dual-purpose floor-standing machine that trims leafy matter from the flowers of plants, and also isolates trichome crystals or fine material from such trim. A floor-standing frame of detachable pieces enable onsite assembly and disassembly, and provide mechanical support for an electric motor and a horizontal axle driven at variable speeds by the motor. A tumbler drum mounted is inside a top end of the floor-standing frame on the horizontal axle. Such is formed by opposing, parallel, and equal-sized left and right tumbler drum end cap pans coaxially disposed on the horizontal axle to define a right cylinder with open walls.

A rectangular-shaped porous covering has a width sufficient to stretch over and between an open space between the opposing left and right tumbler drum end cap pans, and has a length sufficient to completely wrap around the circumference of both the opposing, parallel, and equal-sized left and right tumbler drum end cap pans. A door flap is disposed in the rectangular-shaped porous covering and provides for dried plant material to be loaded-in and unloaded-out of the interior spaces of the tumbler drum.

A funnel bag chute is disposed inside the floor-standing frame and outside a bottom half of the tumbler drum. It is sized and mounted to allow free rotation of the tumbler drum within. A first removable basin is initially positioned on a floor below the funnel bag chute to catch fine materials that pass through rectangular-shaped porous covering. A second removable basin is subsequently positioned on the floor below the funnel bag chute to catch coarse materials that do not pass through rectangular-shaped porous covering and that must be unloaded via the door flap.

Tumbling dry flowers the way the equipment and methods described herein do will produce airborne clouds of valuable fine material or trichome crystals and other fines and powders including mildew spores. A removable dustcover that fully shrouds the tumbler drums in FIGS. 1A, 1B, 1C, 2, 3B, 3E, 4B, 5, and 6, should be in position whenever the tumbler drum is turning more than a few RPM. Otherwise, such airborne clouds can interfere with, annoy, trigger allergies, or even harm the health of workers and users in the vicinity. Profits are also improved by keeping the airborne fine material or trichome crystals from dispersing and becoming irretrievable. In some embodiments, the gentle tumbling action may minimize flower breakage.

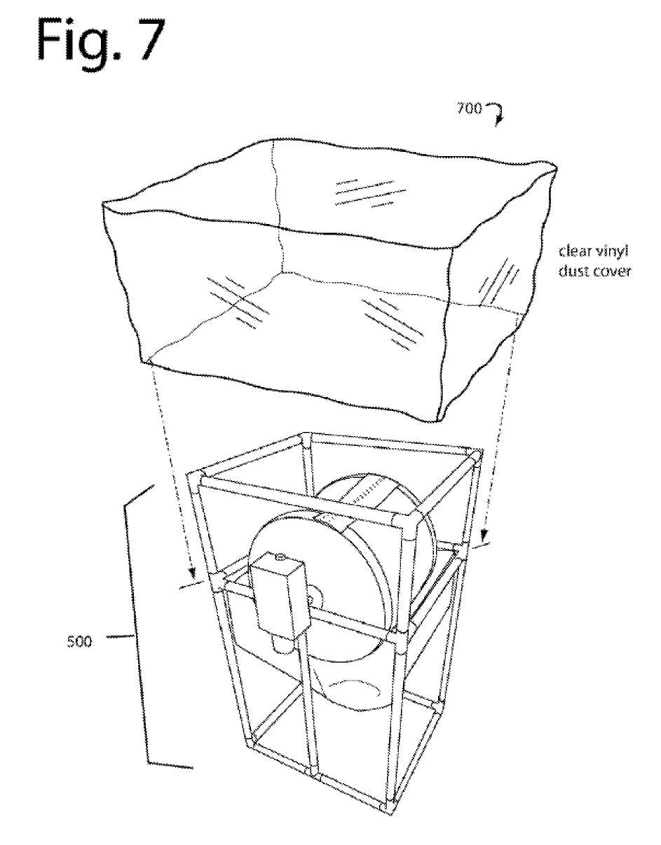

FIG. 7 represents such a dustcover 700 made of clear vinyl that is cut and stitched to just fit over the top half of the low-cost trimmer 500 (FIG. 5). Any trichome crystals that collect inside after use can be scraped off or wiped clean. Clear vinyl material is preferred so that the user can verify the speed settings are producing a continuous curling wave of dry material tumbling around over the horizontal axle 552 (FIG. 5), and see when the equipment should be stopped for a next step in the process.

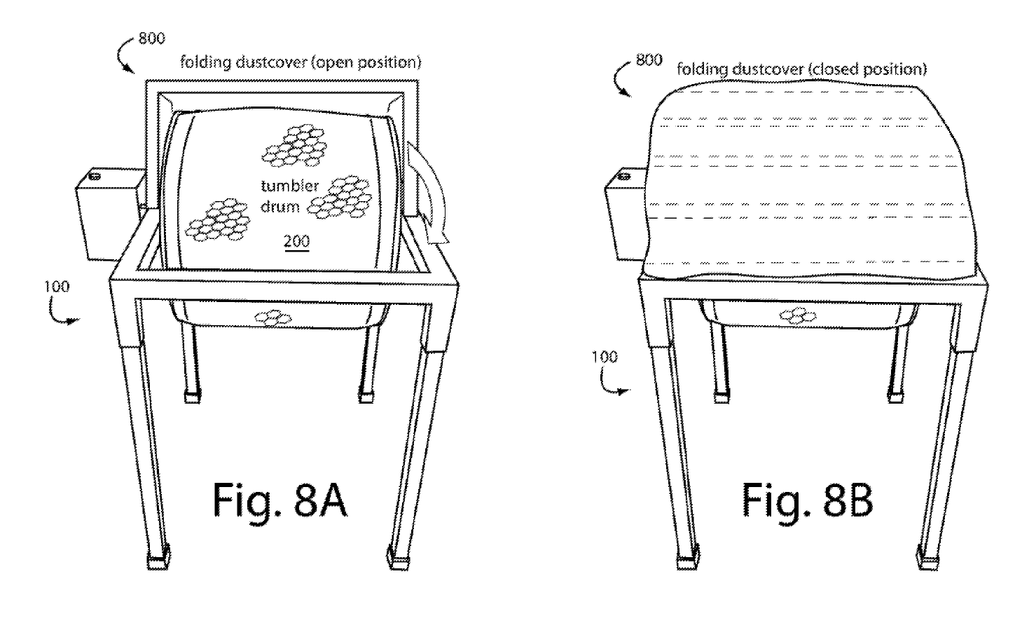

FIGS. 8A and 8B represents a folding dustcover 800 that resembles the folding top of a baby carriage. A folding top frame is covered with clear vinyl that is cut and stitched in a half dome to fit over trimmer 100 (FIG. 1A). After use, trichome crystals that collected inside can be scraped off or wiped clean. Here too, clear vinyl material is preferred so that the user can verify the variable speed motor settings are producing a continuous curling wave of dry material tumbling around over the horizontal axle 110 (FIGS. 1A, 1B).

Embodiments of the present invention do not use blades, and do not require lubrication of any part that comes into contact with the flower being processed. There is not any maintenance associated with such cleaning.

Embodiments of the present invention may be suitable for wide range of medicinal or aromatic herbs including but not limited to tarragon, mint, melissa, sage, and thyme. Other embodiments may separate almost all kinds of products which have a different specific gravities such as fruits and vegetables. These embodiments may separate stems and leaves from vegetables, sort or grade vegetables, fruits or other dried products including green beans, soybeans, cabbage or spinach. Other embodiments may separate immature kernals from cereal grains such as wheat, barley, oilseed rape, peas, beans, cocoa beans, hazelnuts or linseed. Other embodiments may separate coffee beans, peanuts, cocoa beans, peas, maize, sunflower seeds, tea leaves, rice, wheat, sesame, or other food grains. Other embodiments may be used to extract pollens from flowers such as flower pollen, pine pollen, or cannabis pollen. Other embodiments may trim leaves from flowers such as cannabis or hops flowers.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the “true” spirit and scope of the invention.

1. A multi-purpose floor-standing machine that trims leafy matter from the flowers of plants, and that isolates fine material from such trim, comprising:
a floor-standing frame of detachable pieces that enable onsite assembly and disassembly, and that provides support for an electric motor and a horizontal axle driven at variable speeds by the motor;
a tumbler drum mounted inside the top end of the floor-standing frame on the horizontal axle and formed by opposing, parallel, and equal-sized left and right tumbler drum end cap pans coaxially disposed on the horizontal axle to define a right cylinder with open walls;
a rectangular-shaped porous covering having a width sufficient to stretch over and between an open space between the opposing left and right tumbler drum end cap pans, and a length sufficient to completely wrap around the circumference of both the opposing, parallel, and equal-sized left and right tumbler drum end cap pans;
a door flap disposed in the rectangular-shaped porous covering and providing for dried plant material to be loaded in and unloaded out of the interior spaces of the tumbler drum;
a funnel bag chute disposed inside the floor-standing frame and outside a bottom half of the tumbler drum, and sized and mounted to allow free rotation of the tumbler drum within;
a first removable basin positioned on a floor below the funnel bag chute to catch fine materials that pass through rectangular-shaped porous covering; and
a second removable basin positioned on the floor below the funnel bag chute to catch coarse materials that do not pass through rectangular-shaped porous covering and are unloaded via the door flap.

2. The machine of claim 1, wherein the rectangular-shaped porous covering comprises ¼″ to ½″ nylon netting and the fine materials caught in the first removable basin are leafy trim.

3. The machine of claim 1, wherein the rectangular-shaped porous covering comprises ¼″ to ½″ nylon netting and the coarse materials caught in the second removable basin are trimmed flowers of plants.

4. The machine of claim 1, wherein the rectangular-shaped porous covering comprises silkscreen and the fine materials caught in the first removable basin are isolated trichome crystals.

5. The machine of claim 1, wherein the rectangular-shaped porous covering comprises silkscreen and the coarse materials caught in the second removable basin are trimmings of flowers of plants.

6. The machine of claim 1, wherein the tumbler drum, the horizontal axle, the electric motor, and a distal support bearing are interconnected to one another with female and male pipe threaded parts.

7. The machine of claim 1, further comprising:
a dustcover that is positioned over the tumbler drum to prevent the escape of airborne particles generated from the dried plant material turning inside.

8. A method of trimming extraneous matter from the flowers of plants, comprising:
loading a quantity of untrimmed and dried flowers of plants into a cylindrical tumbler drum formed of nylon netting or mesh screen with a horizontal axle;
turning the cylindrical tumbler drum at 25 to 45 RPM for three to five minutes or until a substantial reduction in a material dropping with gravity through the nylon netting or mesh screen is observed;
catching said trim material dropping with gravity through the nylon netting or mesh screen with a funnel bag chute placed around and under the cylindrical tumbler drum as it turns on said horizontal axle, and funneling said trim material into a removable basin below; and
unloading a quantity of now trimmed and dry seedless flowers from the cylindrical tumbler drum into another removable basin placed below.

9. The method of claim 8, further comprising:
opening a door flap in the nylon netting or mesh screen to load the quantity of untrimmed and dried seedless flowers when such door flap is positioned by rotating it to the top of the cylindrical tumbler drum.

10. The method of claim 8, further comprising:
opening a door flap in the nylon netting or mesh screen to unload by gravity the quantity of now trimmed and dry seedless flowers when such door flap is positioned by rotating it to the bottom of the cylindrical tumbler drum.

11. A machine for trimming extraneous matter from the flowers of plants, comprising:
a cylindrical tumbler drum formed of nylon netting and mounted to turn on a horizontal axle, and providing for a loading a quantity of untrimmed and dried seedless flowers of female cannabis plants;
a motor and/or hand crank connected to turn the cylindrical tumbler drum at variable speed of 0-45 RPM for about five minutes or until a substantial reduction in a trim material dropping with gravity through the nylon netting occurs;
a funnel bag chute placed around and under the cylindrical tumbler drum, and that allows the cylindrical tumbler drum to turn freely on said horizontal axle, and that is configured to catch said trim material as it drops with gravity through the nylon netting;
a removable basin placed below the funnel bag chute and on the floor to receive said trim material while the cylindrical tumbler drum is turned; and
another removable basin placed below the funnel bag chute and on the floor to receive a quantity of now trimmed and dry seedless flowers from the cylindrical tumbler drum after it stops turning.

12. The machine of claim 11, further comprising:
a door flap in the nylon netting opened to load the quantity of untrimmed and dried seedless flowers when such door flap is positioned by rotating it to the top of the cylindrical tumbler drum.

13. The machine of claim 11, further comprising:
a door flap in the nylon netting opened to unload by gravity the quantity of now trimmed and dry seedless flowers when such door flap is positioned by rotating it to the bottom of the cylindrical tumbler drum.

14. The machine of claim 11, further comprising:
a dustcover that is positioned to shroud the tumbler drum to prevent a dispersal of airborne particles produced by an agitation of any dried plant material turning inside.
